(19) United States
(12) Patent Application Publication
(10) Pub. No.: US 2013/0112805 A1
(43) Pub. Date: May 9, 2013

(54) METHOD FOR REDUCING REQUIREMENTS FOR AIRCRAFT BRAKE SIZE, COMPLEXITY, AND HEAT DISSIPATION

(71) Applicant: Isaiah W. Cox, Baltimore, MD (US)

(72) Inventor: Isaiah W. Cox, Baltimore, MD (US)

(73) Assignee: BOREALIS TECHNICAL LIMITED, London (GB)

(21) Appl. No.: 13/543,768

(22) Filed: Jul. 6, 2012

Related U.S. Application Data
(60) Provisional application No. 61/504,877, filed on Jul. 6, 2011.

(51) Int. Cl. B64C 25/36; B64C 25/42

(52) U.S. Cl. CPC B64C 25/36; B64C 25/42
USPC 244/50; 301/6.2

(57) ABSTRACT

A method is provided for optimizing requirements for brake size, complexity, and heat dissipation capability in an aircraft, wherein the aircraft is powered during ground travel by an onboard wheel drive assembly, including controllable drive means, mounted on at least one aircraft wheel, and ground travel is controlled by the pilot to move the aircraft on the ground without relying on the operation of the aircraft engines, while substantially minimizing brake use between landing and takeoff. Brakes can be optimally sized and configured to meet landing and taxi requirements, resulting in reduced brake size and complexity and increased effective heat dissipation. Substantially minimizing brake use during taxi produces improved brake cooling, substantially eliminating delays caused by slow brake heat shedding and enables rapid aircraft turnaround between landing and takeoff.

### PRIORITY CLAIM

This application claims priority from U.S. Provisional Patent Application No. 61/503,877, filed Jul. 6, 2011, the disclosure of which is incorporated herein by reference.

### TECHNICAL FIELD

The present invention relates generally to aircraft brake requirements and specifically to a method for reducing requirements for aircraft brake size, complexity, and heat dissipation.

### BACKGROUND OF THE INVENTION

Aircraft brake operational requirements are based on various factors, including but not limited to taxi brake load. Taxi brake load may depend on factors such as engine idle thrust. Brakes are used after an aircraft has landed to control the speed of aircraft ground movement as the aircraft travels from the point of touchdown to a gate or parking location and then from the departure gate to a runway for takeoff. In an aircraft that uses its engines to power ground movement, establishing an optimum reverse thrust level as soon as possible after an aircraft touches down helps to minimize heat buildup in the brakes and keep brake temperatures within a desired range. However, improper or excessive brake application causes high brake temperatures. Not only does this increase brake wear, but more time is needed for the brakes to cool between taxi after landing and taxi for takeoff. Brake heat is not effectively dissipated under these circumstances, and takeoff of the aircraft must be delayed until the brakes have cooled sufficiently.

An additional challenge resulting from sustained high brake temperatures is the potential damage to aircraft tires. Even when an aircraft tire is properly inflated and operated at moderate taxi speeds, the amount of heat generated during ground travel exceeds the amount of heat dissipated by the tire. The additional heat generated by the prolonged or improper application of brakes to control the aircraft's taxi speed can promote tire wear as well as brake wear. When taxi distances are long, both tires and brakes can have a higher than optimal temperature, which can delay takeoff and increase aircraft turnaround time.

In the past, when an aircraft manufacturer made the decision to introduce a new aircraft design on the market, the aircraft model being replaced was retired and no longer manufactured. However, in the current economy, the time and money required to develop and bring new aircraft designs and models to market can be considerable. Aircraft are not retired as early as they once were, and aircraft useful life is longer today than when new models were introduced more frequently. Technology has improved fuel efficiency, moreover, and older aircraft are not as fuel efficient as newer aircraft. The high cost of fuel today and the unpredictability of future fuel costs and supplies are also significant factors to be considered. Consequently, aircraft manufacturers desiring to update their aircraft offerings to take advantage of new technology without the time and expense of developing a completely new design have looked to alternate approaches. One approach is re-engining an aircraft, which essentially involves installing a new, technologically updated model of engine on an existing model of aircraft, as an alternative to the development of a completely new aircraft design. The advantages of the fuel efficiency of new engine technology can be combined with the cost saving of using an existing, proven aircraft body design. Although some in the industry view re-engining as a stop gap measure that allows a manufacturer to present something new while buying time to complete development of an entirely new aircraft, others recognize the improvements in aircraft operating efficiency possible with such an approach.

Replacing an aircraft's main power plant is not necessarily as simple as switching out the old engine for a new one. Other, original, aircraft components have been specifically engineered to work effectively with the operating parameters of the original engine. For example, original structures in and around the engine environment are likely to require replacement or, at a minimum, modification. These structures include pylons and nacelles. In addition, the wing and wing box may not be strong enough to support a new engine design, and these structures may require strengthening. The installation of a new engine is also acknowledged to require additions to an aircraft's avionics.

A re-engined aircraft typically produces higher idle thrust upon landing than an aircraft equipped with its original engine. The brakes originally supplied with the aircraft may not be able to function effectively with the replaced engine to slow the aircraft after landing and/or handle the taxi brake load required. Brakes may be larger and more complex than required for a re-engined aircraft and, as a result, may not be able to dissipate heat effectively Replacing an aircraft's engines could, therefore, necessitate replacement of the aircraft's brakes in addition to the replacement and/or modification of the other aircraft structures discussed above. These potential consequences of re-engining an aircraft have not been widely acknowledged. Upgrading an aircraft's brakes to compensate for the higher idle thrust produced by a technologically improved engine is not necessarily a simple fix.

An alternative to use of an aircraft's main engines, whether re-engined or not, to move aircraft on the ground, is highly desirable. For example, U.S. Pat. No. 7,469,858 to Edelson, owned in common with the present invention, describes a geared wheel motor design with drive means that may be used to move an aircraft from a stationary position to taxi without relying on aircraft engine operation. While an aircraft can be effectively moved on the ground using this arrangement without regard to whether the aircraft has been re-engined, it is not suggested that aircraft brake size and complexity could be reduced or that heat dissipation resulting from brake or other aircraft wheel component use during taxi could be increased.

A need exists, therefore, for a method of achieving optimum brake function and heat dissipation during aircraft ground travel. A need additionally exists for a method of optimizing brake function and heat dissipation in an aircraft wheel powered by drive means to power the aircraft during ground travel without reliance on aircraft main engines, wherein optimal brake function is based on taxi load requirements so that requirements for brake size and complexity can be reduced and heat dissipation capability is increased.

### SUMMARY OF THE INVENTION

It is a primary object of the present invention to provide a method for achieving optimum brake function on aircraft equipped with drive means that powers aircraft ground travel without reliance on aircraft engines that is based on taxi load.

It is another object of the present invention to provide a method for optimizing the size, complexity, and heat dissipation characteristics of the brakes of an aircraft provided with at least one wheel assembly with a drive means mounted on at least one wheel that controls movement of the aircraft on the ground independently of the aircraft engines.

It is an additional object of the present invention to provide a method for optimizing the size, complexity, and heat dissipation characteristics of the brakes of an aircraft with at least one wheel assembly with a drive means that controls movement of the aircraft on the ground independently of the aircraft engines after an aircraft's original engine has been replaced with a new, technologically advanced engine.

It is a further object of the present invention to provide a method for reducing the requirements for size, complexity, and heat capability for the brakes on any aircraft in which brake requirements are set by taxi brake load requirements.

It is yet another object of the present invention to provide a method for providing aircraft with brakes designed to satisfy landing and/or runway requirements, wherein brake requirements are set at least in part by taxi brake load instead of landing load.

In accordance with the aforesaid objects, a method for reducing the requirements for aircraft brake size, complexity, and heat dissipation capability is provided. The present method optimizes requirements for brake size, complexity, and heat dissipation capability in an aircraft, wherein the aircraft is powered by an onboard wheel drive assembly, including controllable drive means, mounted on at least one aircraft wheel, and ground travel is controlled by the pilot to move the aircraft on the ground without relying on the operation of the aircraft engines, while substantially minimizing brake use between landing and takeoff. Brakes can be optimally sized and configured to meet landing and taxi requirements, resulting in reduced brake size and complexity and increased effective heat dissipation. Substantially minimizing brake use during taxi produces improved brake cooling, substantially eliminating delays caused by slow brake heat shedding and produces rapid aircraft turnaround between landing and takeoff. After the aircraft has touched down and reached desired taxi speed, the engines are completely shut down, and the pilot controls and operates the preferably electric drive means. The aircraft taxis to its parking location solely under the power of the pilot-controlled drive wheel assembly drive means without reliance on the aircraft engines. As a result, the aircraft brakes are not required to overcome engine thrust loads and do not have to be applied as frequently as in the past. Brake requirements are based primarily on taxi load, and the size, complexity, and heat dissipation characteristics of the brakes can be reduced because brakes are used only minimally during taxi. The present method is contemplated for use with any aircraft for which the brake requirements are set at least in part by taxi brake load instead of landing load.

Other objects and advantages will be apparent from the following description, claims, and drawings.

### BRIEF DESCRIPTION OF THE DRAWINGS

FIG. 1 illustrates an aircraft equipped with a wheel assembly with a drive means mounted on the nose wheels according to the present invention to drive the aircraft during taxi and provided with brakes having optimum size, complexity, and heat dissipation characteristics; and

FIG. 2 is a schematic illustration of an aircraft nose wheel assembly with drive assemblies powered by drive means in accordance with the present invention.

### DESCRIPTION OF THE INVENTION

The method of the present invention achieves improvements in aircraft brake structure and operation not heretofore possible. Currently, after an aircraft touches down, the aircraft brakes are used in combination with other aircraft structures and engine reverse thrust to increase drag and slow the aircraft to taxi speed, usually about 20 knots. Aircraft are then driven on the ground during taxi with one or more aircraft main engines at a low thrust setting, using the aircraft brakes on landing gear wheels as needed to control travel speed. Methods of braking an aircraft are known. One method is described by Thompson in Patent Application Publication US 2008/0283660, assigned to Airbus UK Limited, the disclosure of which is incorporated herein by reference.

The present invention does not require the use of the aircraft engines to drive the aircraft on the ground. Rather, at least one drive wheel assembly, with a drive means that is preferably an electric drive means powered by the aircraft's auxiliary power unit (APU), is provided on a nose or main aircraft wheel to drive the aircraft while the aircraft is maneuvered on the ground once the desired taxi speed has been reached. This arrangement provides motive power without the need for operation of the aircraft engines as the aircraft travels on the ground during taxi between landing and takeoff.

Aircraft brakes on aircraft that use engines during taxi can build up heat upon landing to near a maximum tolerance. Ideally, an aircraft taxis in to its parking location and then taxis out again as soon as possible, keeping turnaround time as short as possible. The brakes must be cooled sufficiently so that a Rejected Takeoff (RTO) is possible if a takeoff roll cannot be started. If the brakes have not cooled sufficiently, takeoff is delayed until the brakes have cooled down to an acceptable temperature. An aircraft that uses its engines for ground travel cannot land and expect to begin a takeoff roll 5 minutes later. Brakes should be able to shed enough heat after landing to allow for a rapid turnaround in addition to handling landing and RTO cases. An aircraft equipped with a drive wheel assembly and drive means in accordance with the present invention uses the brakes only minimally during taxi compared to an aircraft that must use its engines for ground travel. Consequently, with the present method, brakes can be sized optimally as needed for the landing and RTO cases. Whether the aircraft has its originally installed engine or whether the aircraft has been re-engined, the brakes do not have to be sized or configured to handle the kinds of braking needs required by engine-on taxi and rapid turn around with engine-on taxi.

The present invention can also maximize aircraft tire performance and safety and reduce costs of tire replacement due to overheated tires related to the generation of excess brake heat. The control of aircraft taxi that is possible with the present method produces more consistent taxi speeds and requires a significantly lower level of brake application than in the past. Consequently, the aircraft's brakes contribute only minimally, if at all, to the heat generated by aircraft tires, and this heat should be substantially reduced by the present method. With the present method after an aircraft has touched down and reached desired taxi speed, the engines are completely shut down, and the pilot controls and operates the drive means to drive the aircraft to its parking location solely under the power of a drive wheel assembly drive means without reliance on the aircraft engines. As a result, the aircraft brakes are not required to overcome engine thrust loads and will be applied significantly less frequently than in the past. With the present method, brake requirements are based primarily on taxi load, and the size, complexity, and heat dissipation characteristics of the brakes can be reduced because brakes are used only minimally during taxi. The present method is contemplated for use with any aircraft for which the brake requirements are set at least in part by taxi brake load instead of landing load.

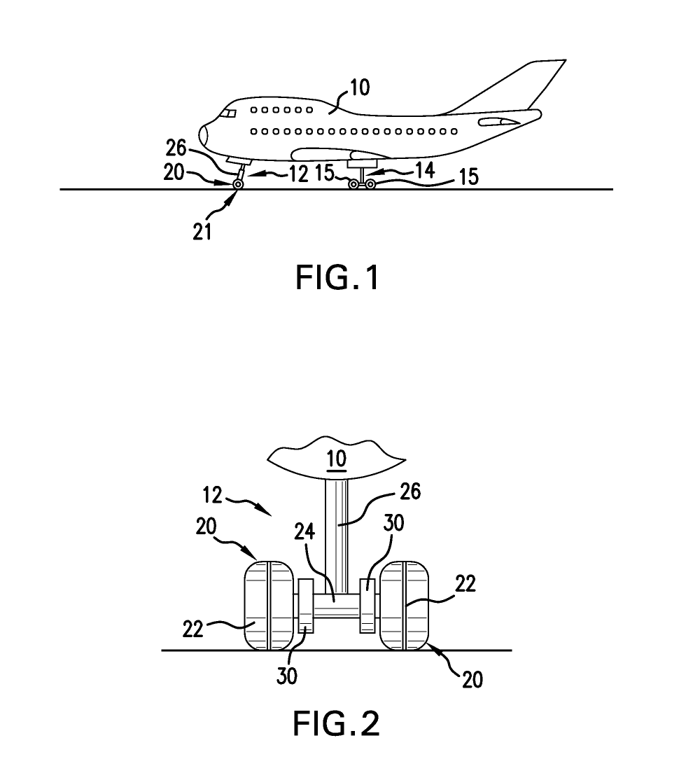

Referring to the drawings, FIG. 1 illustrates, diagrammatically, an aircraft 10 during taxi. A nose wheel landing gear is shown at 12, and a main landing gear is shown at 14. FIG. 1 shows the aircraft 10 with a drive wheel assembly 20 installed on the nose wheel landing gear assembly 12, which is the preferred site for installation. The drive wheel assembly 20 could also be installed on one or more of the main landing gear wheels 14. The aircraft's brakes 15 are installed on the main landing gear wheels 14. The brakes 15 are preferably selected and sized to function cooperatively with drive wheel assemblies installed on either or both of an aircraft's nose or main wheels as discussed herein.

FIG. 2 illustrates, diagrammatically, one possible arrangement of drive means useful in the method of the present invention. The drive means are mounted in connection with a pair of aircraft drive wheels, preferably the wheels of a nose landing gear wheel assembly 12 (FIG. 1). The embodiment of FIG. 2 shows one possible arrangement of components in a nose landing gear assembly 12. Two wheels 20 with tires 22 are shown rotatably mounted at opposite ends of an axle 24. The axle 24 is mounted on a landing gear strut 26 that is connected to the aircraft 10. FIG. 2 shows two drive means 30 mounted adjacent to each wheel 20 in driving communication with the wheels 20 and axle 24. Both drive means 30 are not required for the present method to effectively move an aircraft during taxi in connection with the aircraft's brakes. A single wheel drive means 30 can power a nose or main wheel to move an aircraft on the ground as described herein. The two wheel drive means 30 shown are positioned interiorly or inboard of the wheels 20 and mounted on the axle 24. Other numbers of drive means and variations in positions of drive means are also contemplated to be within the scope of the present invention. For example, additional drive means could be mounted on one or more main wheels in a main landing gear wheel assembly 14. Moreover, drive means could be mounted substantially completely within a wheel, outboard or a wheel, or in a location where a drive means can be operatively and drivingly connected to a wheel.

The aircraft's brakes 15 are not shown in detail in the drawings. Aircraft brakes are well known in the art and can be any type of brakes and or brake systems that would be originally installed on a specific model of aircraft or could be retrofitted on the aircraft. For example, disc brakes are commonly used. Brake requirements are set, at least in part, by taxi brake load. As discussed herein, the present invention reduces the requirements for brake size, complexity, and heat dissipation capability. While steel has been a preferred material for brake discs, carbon disc brakes, which are lighter, are being retrofitted on existing aircraft to save weight and, therefore, fuel and other costs.

The preferred drive means 30 for use with the present method is an electric motor and can be a totally enclosed machine capable of operating for about 5 to 10 minutes at maximum torque and for 30 to 40 minutes at cruise torque, relying primarily on the motor itself as the heat sink. An electric motor preferred for use with an aircraft wheel assembly in accordance with the present invention could be any one of a number of designs, for example an inside-out motor attached to a wheel hub in which the rotor can be internal to or external to the stator, such as that shown and described in U.S. Patent Application Publication No. 2006/0273686, the disclosure of which is incorporated herein by reference. A toroidally-wound motor, an axial flux motor, or any other electric motor geometry known in the art is also contemplated to be suitable for use in the present invention.

The drive means or electric motor selected should be able to move an aircraft landing gear wheel at a desired speed and torque for efficient taxi. One kind of electric drive motor preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. Any form of electric motor capable of driving a landing gear wheel to move an aircraft on the ground, including but not limited to electric induction motors, permanent magnet brushless DC motors, and switched reluctance motors may also be used, as can hydraulic and pneumatic motors. Other motor designs capable of high torque operation across the desired speed range that can be integrated into an aircraft wheel to function as described herein may also be suitable for use in the present invention. A particularly preferred motor is a high phase order induction motor with a top tangential speed of about 15,000 linear feet per minute and a maximum rotor speed of about 7200 rpm. With an effective wheel diameter of about 27 inches and an appropriate gear ratio, an optimum speed of about 28 miles per hour (mph) can be achieved.

The wheel drive assembly and drive means of the present method are specifically designed to be retrofitted on existing aircraft without requiring changes to existing wheel structures, including the brakes. A major advantage of the design of the wheel 20 and drive means 30 is achieved by the continued use of the existing tires, axle 24, and landing gear piston (not shown) already in use on an aircraft. Since these structures are not altered from their original condition or otherwise changed in any way by the installation of the present wheel and drive means assembly, the rim width, tire bead, and bead seat would not require re-certification by the FAA or other authorities, thus eliminating a potentially time consuming and costly process. As a result, the wheel drive assembly described herein is especially well suited for installation on existing aircraft.

Another advantage of using the wheel drive assembly design of the present invention in an aircraft landing gear assembly is the ability to minimize spin-up loads for the wheel by removing considerable motor mass as compared to existing landing gear designs that include motors. The motor is able to spin-up and match the wheel speed before a clutch is engaged. This allows the drive means to connect or disconnect as required without bringing the aircraft to a halt before engaging or disengaging the drive means or motor assembly or a gear system drivingly connected to the assembly.

The method described herein is intended for use with any aircraft to reduce requirements for brake size, complexity, and heat dissipation capability. The present method is contemplated to be useful with any aircraft, whether re-engined or not, in which the brake requirements are set at least in part by taxi brake load rather than landing brake load, which effectively applies to most aircraft.

Another possible application of the present invention relates to the reduction in brake size possible when an aircraft has been retrofitted with a wheel driver assembly and drive means in accordance with the present invention. Brakes correspondingly sized as required only by landing and/or runway requirements when an aircraft is driven on the ground by a drive means in accordance with the present invention will be smaller than current brakes, resulting in aircraft weight reduction. This method of reducing aircraft weight, as well as component size and complexity, could be applied both to aircraft with original engines and to re-engined aircraft. The reduced use of brakes with the drive wheel assembly and drive means of the present invention, moreover, effectively avoids the kind of heat build up that occurs with engine-on taxi so that heat is efficiently dissipated, and delays due to cooling the brakes for takeoff are eliminated.

While the present invention has been described with respect to preferred embodiments, this is not intended to be limiting, and other arrangements and structures that perform the required functions are contemplated to be within the scope of the present invention.

### INDUSTRIAL APPLICABILITY

The apparatus and method of the present invention will find its primary applicability when it is desired to achieve cost savings and other efficiencies, especially with respect to the size, complexity, and heat dissipation characteristics of the aircraft's brakes, that result when an aircraft is equipped with a wheel drive assembly with electric or other drive means to power movement of the aircraft on the ground between landing and takeoff.

1. A method for reducing the requirements for aircraft brake size and heat dissipation capability comprising equipping an aircraft with at least one onboard wheel drive assembly with drive means, wherein said wheel drive assembly is controllably mounted on at least one aircraft wheel so that said drive means is controllable to power the aircraft wheel and move said aircraft independently on the ground without reliance on the aircraft main engines; and providing brakes selected for optimal size and heat dissipation capability during said independent aircraft ground movement.

2. The method of claim 1, wherein said brakes are selected for optimal size and heat dissipation capability based on aircraft taxi brake load.

3. The method of claim 2, wherein said aircraft is equipped with at least one wheel drive assembly mounted on at least one nose landing gear wheel.

4. The method of claim 2, wherein said aircraft is equipped with at least one wheel drive assembly mounted on at least one main landing gear wheel.

5. The method of claim 1, wherein said drive means comprises a drive means selected from the group comprising high phase order electric motors, electric induction motors, permanent magnet brushless DC motors, switched reluctance motors, hydraulic motors, and pneumatic motors.

6. The method of claim 1, wherein brake heat build up is minimized and brake heat dissipation is maximized during aircraft taxi by providing aircraft brakes sized and configured to optimize heat dissipation in said aircraft wheel.

7. A method for avoiding brake heat build up and increasing brake heat dissipation in an aircraft comprising providing an aircraft onboard wheel drive assembly comprising electric drive means mounted on at least one aircraft nose or main landing gear wheel for powering the ground movement of said aircraft; and substantially minimizing operation of aircraft brakes during aircraft ground movement, whereby brake heat build up is avoided and brake heat dissipation is increased, wherein delays in aircraft turnaround between landing and takeoff caused by brake cooling time are substantially eliminated.

8. The method of claim 7, wherein said aircraft is maneuvered on the ground by controlling said onboard wheel drive assembly drive means, and operational requirements of said brakes are set by the aircraft taxi load.

9. A method for retaining brakes originally supplied with an aircraft when the aircraft is re-engined comprising providing a re-engined aircraft equipped with brakes original to the aircraft; providing an onboard wheel drive assembly with drive means mounted on at least one aircraft wheel, wherein said drive means are controllable to power the ground movement of said aircraft independently of said re-engined aircraft; and controlling said drive means to move the aircraft on the ground with minimal use of said brakes.

10. The method of claim 9, wherein operating requirements of said brakes are set by aircraft runway operation brake load.

11. The method of claim 9, wherein said brakes are configured to have a size corresponding to operational requirements set by aircraft landing and taxi load.

12. A method for reducing aircraft brake and tire wear due to heat generation during taxi comprising providing an onboard wheel drive assembly with electric drive means mounted on at least one aircraft nose or main wheel for powering the ground movement of said aircraft; and providing brakes sized and configured to comply with operational requirements set by aircraft taxi load, whereby efficient heat dissipation during aircraft ground movement is maximized and aircraft brake and tire wear caused by heat are reduced.
